(19) United States
(12) Patent Application Publication
(10) Pub. No.: US 2016/0188058 A1
(43) Pub. Date: Jun. 30, 2016

(54) TOUCH DEVICE UTILIZING METAL MESH AS TOUCH SENSOR

(71) Applicants: INTERFACE OPTOELECTRONIC (SHENZHEN) CO., LTD., SHENZHEN (CN); GENERAL INTERFACE SOLUTION LIMITED, Miaoli County (TW)

(72) Inventors: CHIA-CHUN TAI, Hsinchu (TW); WEI-CHUNG CHUANG, Hsinchu (TW); YEN-HENG HUANG, Hsinchu (TW)

(73) Assignees: GENERAL INTERFACE SOLUTION LIMITED, Miaoli County (TW); INTERFACE OPTOELECTRONIC (SHENZHEN) CO., LTD., SHENZHEN (CN)

(21) Appl. No.: 14/742,871

(22) Filed: Jun. 18, 2015

(30) Foreign Application Priority Data
Dec. 31, 2014 (CN) 201410846875.3

(51) Int. Cl. G06F 3/041

(52) U.S. Cl. CPC G06F 3/0412

(57) ABSTRACT

A touch-sensitive device using a printed metal mesh includes a touch sensing film and a display module. The touch sensing film includes a first metal mesh layer and a protection layer. The protection layer covers the first metal mesh layer and is located at a side of the touch sensing film adjacent to the display module.

### CROSS-REFERENCE TO RELATED APPLICATIONS

This application claims priority to Chinese Patent Application No. 201410846875.3 filed on Dec. 31, 2014 in the Chinese Intellectual Property Office, the contents of which are incorporated by reference herein.

### FIELD

The present disclosure generally relates to user interface devices.

### BACKGROUND

Touch screens are widely used in electronic devices, such as smart phones and tablet computers, to serve as input/output (I/O) devices of the electronic devices. As touch screens have become ever larger, the conventional technology for fabricating indium-tin oxide-based (ITO-based) transparent electrodes falls short of satisfying the low-cost requirement for touch screen-equipped products. Precision printing technology can produce metal mesh structures that have inherently good conductivity via direct printing on the surface of a substrate. Under the same transparency requirements, metal mesh can provide a benefit of cost reduction compared to conventional ITO-based devices while providing improved electrical conductivity as well.

### BRIEF DESCRIPTION OF THE DRAWINGS

Implementations of the present technology will now be described, by way of example only, with reference to the attached figures.

FIG. 1 is an isometric view of a touch device.

FIG. 2 is an exploded view of the touch device of FIG. 1.

FIG. 3 is a cross-sectional view of the touch device of FIG. 1 taken along line III-III according to a first embodiment.

FIG. 4 is a plane view of a touch sensing film of the touch device of FIG. 3.

FIG. 5 shows the touch sensing film of FIG. 4 electrically coupled to a flexible printed circuit (FPC).

FIG. 6 is a cross-sectional view of a touch device according to a second embodiment.

FIG. 7 is a cross-sectional view of a touch device according to a third embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected.

The present disclosure is described in relation to a touch device.

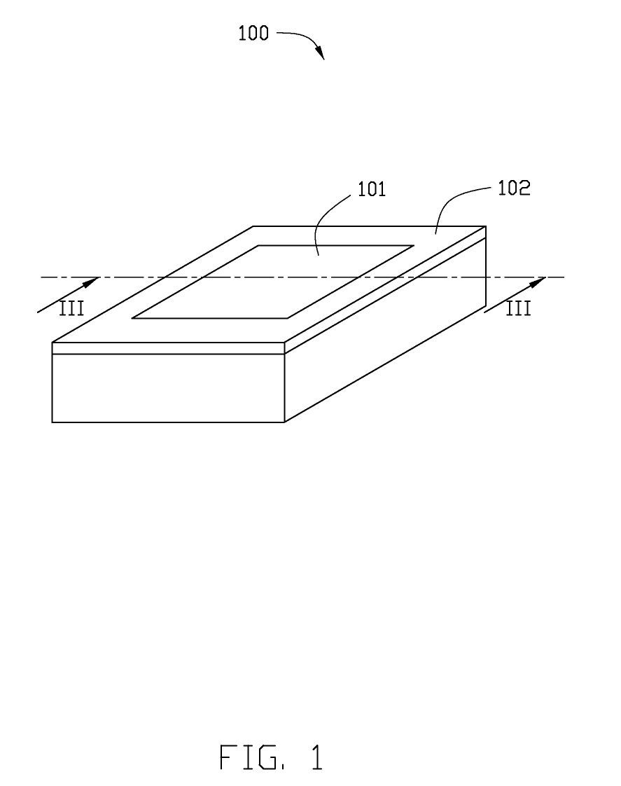

Referring to FIG. 1, FIG. 1 is an isometric view of a touch device 100. The touch device 100 can be a smart phone, a tablet computer, a camera, a personal digital assistant (PDA), or other like devices. The touch device 100 includes an active area (AA) 101 for sensing touch operations on the touch device and a non-active area 102 surrounding the active area 101. In at least one embodiment, the active area 101 also refers to a display area of the touch device 100. The non-active area 102 also refers to a non-display area or a trace area of the touch device 100.

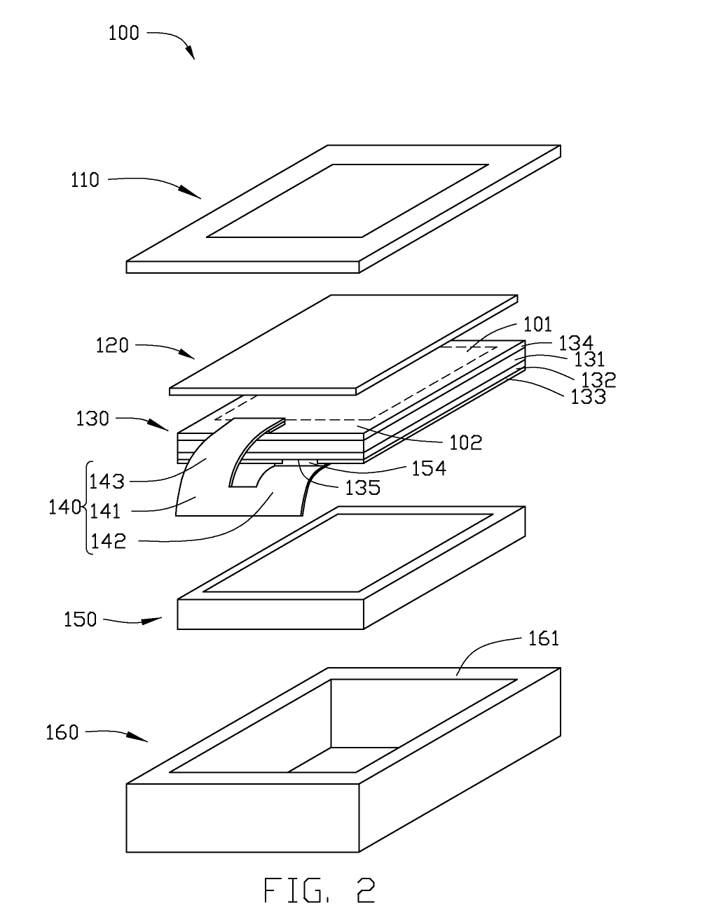

Referring FIG. 2, FIG. 2 is an exploded view of the touch device 100 of FIG. 1. The touch device 100 can include a cover 110, an adhesive layer 120, a touch sensing film 130, a flexible printed circuit (FPC) 140, a display module 150, and a housing 160. The cover 110, the adhesive layer 120, the touch sensing film 130, and the display module 150 are stacked together in that order. In at least one embodiment, the touch sensing film 130 is adhered to the cover 110 by the adhesive layer 120. The FPC 140 is electrically coupled to the touch sensing film 130 and is located at a position corresponding to the non-active area 102. The display module 150 is located at a side of the touch sensing film 130 away from the cover 110. The cover 110 covers the housing 160 to form a receiving space to receive the touch sensing film 130, the FPC 140, and the display module 150.

The touch sensing film 130 can include a substrate 131, a first metal mesh layer 132, a protection layer 133, and a second metal mesh layer 134. The first metal mesh layer 132 is positioned on a first surface of the substrate 131 adjacent to the display module 150. The second metal mesh layer 132 is positioned on a second surface of the substrate 131 opposite to the first surface. The protection layer 133 defines an opening 135 to expose a portion of the first metal mesh layer 132. The FPC 140 includes a main body 141, a first free end 142, and a second free end 143 which are coupled to the main body 141. The first free end 142 is located adjacent to the display module 150 and is electrically coupled to the first metal mesh layer 132 using an anisotropic conductive film 154 passing through the opening 135. The second free end 143 is located adjacent to the cover 110 and is electrically coupled to the second metal mesh layer 134. In at least one embodiment, the second free end 143 can be electrically coupled to the second metal mesh layer 134 using anisotropic conductive adhesives.

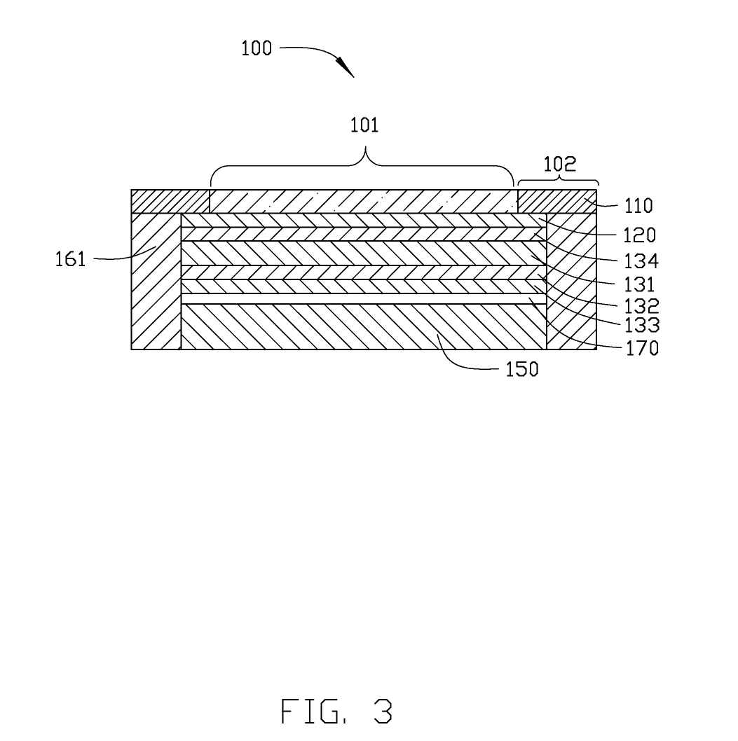

Referring to FIG. 3, FIG. 3 is a cross-sectional view of the touch device taken along line III-III of FIG. 1, according to a first embodiment. The housing 160 includes four sidewalls 161 connected end to end. The cover 110 covers the four sidewalls 161 to form the receiving space to receive the touch sensing film 130 and the display module 150 therein. The display module 150 is located at inner sides of the sidewalls 161 and is at a side of the touch sensing film 130 adjacent to the protection layer 133. In this embodiment, an air gap 170 is defined between the protection layer 133 of the touch sensing film 130 and the display module 150. Thus, the display module 150 and the touch sensing film 130 are coupled by air.

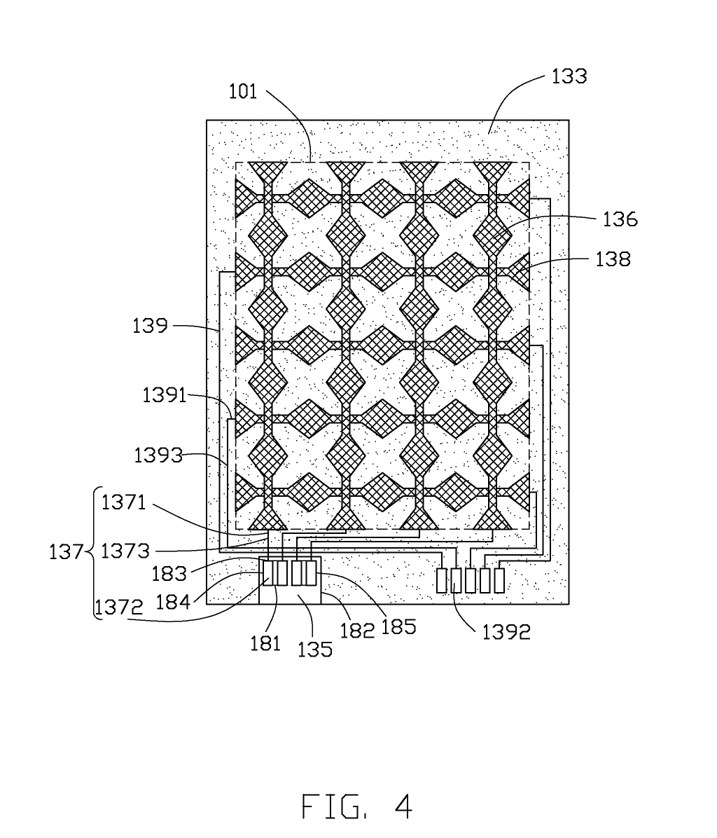

Referring to FIG. 4, FIG. 4 is a plane view of the touch sensing film 130 of FIG. 3. The first metal mesh layer 132 includes a plurality of first metal mesh electrodes 136 and a plurality of first conductive traces 137. The first metal mesh electrodes 136 extend along a first direction and are located to correspond to the active area 101. The first conductive traces 137 are located to correspond to the non-active area 102. The first conductive trace 137 includes a first terminal 1371, a second terminal 1372, and a connection portion 1373 connected between the first terminal 1371 and the second terminal 1372. The first terminal 1371 is electrically coupled to the metal mesh electrode 136, and the second terminal 1372 is electrically coupled to the FPC 140, thereby establishing an electrical connection between the metal mesh electrode 136 and the FPC 140. The protection layer 133 covers the first terminal 1371 and a portion of the connection portion 1373. The second terminal 1372 is not covered by the protection layer 133 and the second terminal 1372 is exposed out of the protection layer 133 through the opening 135. In at least one embodiment, a thickness of the protection layer 133 may be about 2 micrometers (um) to about 20 um. The protection layer 133 can be made of transparent materials such as carboxylated acrylic resins.

In at least one embodiment, a space between the second terminal 1372 of first conductive trace 137 and the protection layer 133 is greater than or equal to one millimeter (mm). The second terminal 1372 of each of the first conductive traces 137 is arranged in a first rectangular region 181 located in the opening 135, a second rectangular region 182 being the extent of the opening 135. In this embodiment, the first rectangular region 181 includes a first edge 183, a second edge 184, and a third edge 185. The first edge of the first rectangular region 181 is adjacent to the connection portion 1373 of the first conductive trace 137. The second edge 184 and the third edge 185 are respectively connected to opposite sides of the first edge 183.

In at least one embodiment, a shortest distance between each of the first, second, and third edges, 183, 184, and 185, and a corresponding edge of the second rectangular region 182 is greater than or equal to one millimeter.

The second metal mesh layer 134 includes a plurality of second metal mesh electrodes 138 and a plurality of second conductive traces 139. The second metal mesh electrodes 138 extend along a second direction perpendicular to the first direction. The second conductive traces 139 are located to correspond to the non-active area 102. The second conductive trace 139 includes a first terminal 1391, a second terminal 1392, and a connection portion 1393 electrically coupled between the first terminal 1391 and the second terminal 1392. The first terminal 1391 is electrically coupled to the second metal mesh electrode 138, and the second terminal 1392 is electrically coupled to the second free end 143 of the FPC 140, thereby establishing an electrical connection between the second metal mesh electrode 138 and the FPC 140.

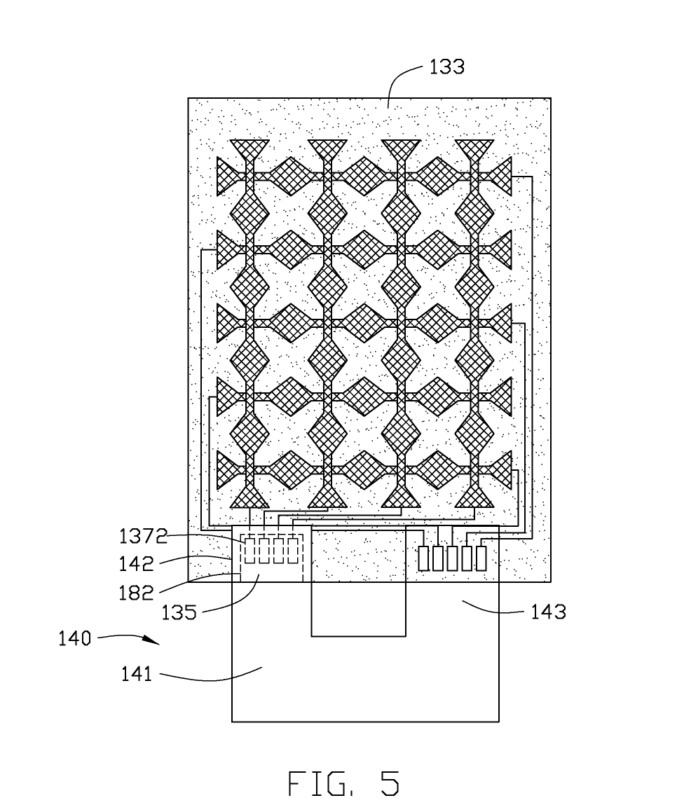

Referring to FIG. 5, FIG. 5 shows the touch sensing film 130 of FIG. 3 electrically coupled to the FPC 140. Under this condition, the first free end 142 covers the second terminal 1372 of the first conductive trace 137 and a portion of the protection layer 133. A shortest distance between the first free end 142 and an edge of the protection layer 133 adjacent to the second terminal 1372 is greater than or equal to three millimeters. Referring to FIG. 2 again, the free end 142 can be electrically coupled to the second terminal 1372 of the first conductive trace 137 via the anisotropic conductive film 154. The anisotropic conductive film 154 also covers a portion of the protection layer 133. A shortest distance between an edge of the opening 135 of the protection layer 133 and an edge of the anisotropic conductive film 154 is greater than or equal to three millimeters.

As described above, the protection layer 133 covers a side of the first metal mesh layer 132 adjacent to the display module 150. During assembly of the touch sensing film 130 and the display module 150, the protection layer 133 can protect the first metal mesh layer 132 from being damaged. Further, the protection layer 133 of the touch sensing film 130 is coupled to the display module 150 by air bonding technology, thus adhesive materials between the protection layer 133 and the display module 150 can be omitted.

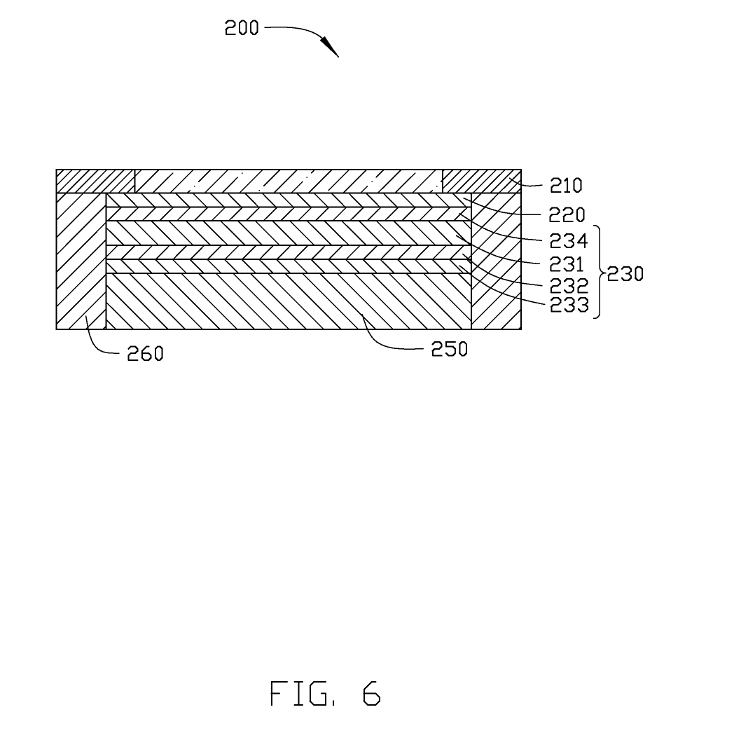

Referring to FIG. 6, FIG. 6 is a cross-sectional view of a touch device 200 according to a second embodiment. In the second embodiment, the touch device 200 is similar to the touch device 100 of the first embodiment. The touch device 200 includes a cover 210, an adhesive layer 220, a touch sensing film 230, a display module 250, and a housing 260. The cover 210, the adhesive layer 220, the touch sensing film 230, and the display module 250 are stacked together in that order. In at least one embodiment, the touch sensing film 230 is adhered to a surface of the cover 210 by the adhesive layer 220. The display module 250 is located at a side of the touch sensing film 230 away from the cover 210. The cover 210 covers the housing 260 to form a receiving space to receive the touch sensing film 230 and the display module 250.

The touch sensing film 230 can include a substrate 231, a first metal mesh layer 232, a protection layer 233, and a second metal mesh layer 234. The first metal mesh layer 232 is formed on a first surface of the substrate 231 adjacent to the display module 250. The second metal mesh layer 232 is formed on a second surface of the substrate 232 opposite to the first surface. The display module 250 is located at a side of the touch sensing film 230 away from the cover 210. In this embodiment, the touch sensing film 230 is directly positioned on the display module 250 and is in contact with the display module 250. That is, the protection layer 233 of the touch sensing film 233 is in direct contact with the display module 250.

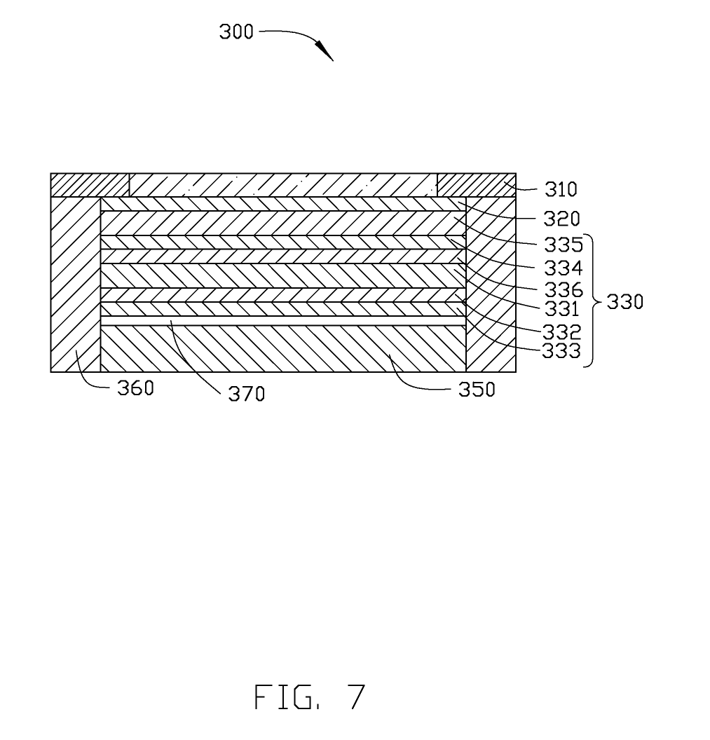

Referring to FIG. 7, FIG. 7 is a cross-sectional view of a touch device 300 according to a third embodiment. In the third embodiment, the touch device 300 is similar to the touch device 100 of the first embodiment. The touch device 300 includes a cover 310, an adhesive layer 320, a touch sensing film 330, a display module 350, and a housing 360. The cover 310, the adhesive layer 320, the touch sensing film 330, and the display module 350 are stacked together in that order. In at least one embodiment, the touch sensing film 330 is adhered to a surface of the cover 310 by the adhesive layer 320. The display module 350 is located at a side of the touch sensing film 330 away from the cover 310. The cover 310 covers the housing 360 to form a receiving space to receive the touch sensing film 330 and the display module 350.

In the third embodiment, the touch sensing film 330 includes a protection layer 333, a first metal mesh layer 332, a first substrate 331, an adhesive material layer 336, a second metal mesh layer 334, and a second substrate 335. The first metal mesh layer 332 is positioned on the first substrate 331, while the second metal mesh layer 334 is positioned on the second substrate 335. The first substrate 331 and the second substrate 335 are adhered together by the adhesive material layer 336. The protection layer 333 is adjacent to the display module 350 and covers the first metal mesh layer 332.

In this embodiment, an air gap 370 is defined between the protection layer 333 of the touch sensing film 330 and the display module 350. Thus, the display module 350 and the touch sensing film 330 are coupled by air bonding. In at least one embodiment, a thickness of the protection layer 333 is about 2 um to about 20 um.

The protection layer 333 can be made of transparent materials such as carboxylated acrylic resins.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A touch device comprising:
a touch sensing film and a display module, the touch sensing film comprising:
a first metal mesh layer and a protection layer, the protection layer covering the first metal mesh layer and located adjacent to the display module.

2. The touch device according to claim 1, wherein the protection layer is located on the display module and is contacted with the display module.

3. The touch device according to claim 1, wherein an air gap is defined between the protection layer of the touch sensing film and the display module.

4. The touch device according to claim 1, wherein the touch device comprising an active area, a non-active area, and a flexible printed circuit located to correspond to the non-active area; the first metal mesh layer comprises a plurality of first metal mesh electrodes and a plurality of first conductive traces; the first metal mesh electrodes extend along a first direction and are located to correspond to the active area, and the first conductive traces are located to correspond to the non-active area; the first conductive trace comprises a first terminal, a second terminal, and a connection portion connected between the first terminal and the second terminal; the first terminal is electrically coupled to the first metal mesh electrode, and the second terminal is electrically coupled to the flexible printed circuit.

5. The touch device according to claim 4, wherein the protection layer covers the first terminal and a portion of the connection portion, and the second terminal is not covered by the protection layer and exposes out of the protection layer via an opening of the protection layer.

6. The touch device according to claim 5, wherein a distance between the second terminal of the first conductive trace and the protection layer is greater than or equal to one millimeter.

7. The touch device according to claim 5, wherein the plurality of first conductive traces are arranged in a first rectangular region, the opening defines a second rectangular region, the first rectangular region is located within the second rectangular region, the first rectangular region comprises a first edge, a second edge, and a third edge, the first edge of the first rectangular region is adjacent to the connection portion of the first conductive trace, the second edge and the third edge are coupled to two opposite sides of the first edge respectively, a shortest distance between each of the first edge, the second edge and the third edge and a corresponding edge of the second rectangular region is greater than or equal to one millimeter.

8. The touch device according to claim 4, wherein the flexible printed circuit covers the second terminal of the first conductive trace and a portion of the protection layer, and a shortest distance between an edge of the of the flexible printed circuit and an edge of the protection layer adjacent to the second terminal is greater than or equal to three millimeters.

9. The touch device according to claim 4, wherein the touch sensing film further comprises a second metal mesh layer isolated from the first metal mesh layer, the second metal mesh layer comprises a plurality of second metal mesh electrodes and a plurality of second conductive traces; the second metal mesh electrodes extend along a second direction perpendicular to the first direction; the second conductive traces are located to correspond to the non-active area; the second conductive trace comprises a first terminal, a second terminal, and a connection portion electrically coupled between the first terminal and the second terminal of the second conductive trace; the first terminal of the second conductive trace is electrically coupled to the second metal mesh electrode, and the second terminal of the second conductive trace is electrically coupled to the flexible printed circuit.

10. The touch device according to claim 9, wherein the touch sensing film further comprises a substrate, the first metal mesh layer is formed on a first surface of the substrate adjacent to the display module, the second metal mesh layer is formed on a second surface of the substrate opposite to the first surface.

11. The touch device according to claim 10, wherein the flexible printed circuit further comprises a first free end and a second free end, the first free end is electrically coupled to the second terminal of the first conductive trace, and the second free end is electrically coupled to the second terminal of the second conductive trace.

12. The touch device according to claim 9, wherein the touch sensing film further comprises a first substrate, a second substrate, and an adhesive material layer, the first metal mesh layer is formed on the first substrate, the second metal mesh layer is formed on the second substrate, and the first substrate and second substrate are adhered together by the adhesive material layer.

13. The touch device according to claim 1, wherein a thickness of the protection layer is about 2 micrometers to about 20 micrometers.

14. The touch device according to claim 1, wherein the protection layer is made of transparent materials.

15. The touch device according to claim 1, wherein the protection layer is made of carboxylated acrylic resins.
